(19) United States
(12) Patent Application Publication
(10) Pub. No.: US 2019/0252830 A1
(43) Pub. Date: Aug. 15, 2019

(54) ELECTRICAL CONNECTOR HAVING UPPER AND LOWER POWER CONTACTS STAMPED TO CONTACT EACH OTHER

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: JUN ZHAO, HUAIAN (CN)

(21) Appl. No.: 16/257,001

(22) Filed: Jan. 24, 2019

(30) Foreign Application Priority Data
Feb. 9, 2018 (CN) 201810133216.3

(51) Int. Cl. H01R 13/6585; H01R 12/72; H01R 13/6582; H01R 13/6594; H01R 43/16; H01R 43/24

(52) U.S. Cl. CPC H01R 13/6585; H01R 12/725; H01R 13/6582; H01R 2107/00; H01R 43/16; H01R 43/24; H01R 13/6594

(57) ABSTRACT

A method of making an electrical connector includes: forming an upper row of contacts each connected between a primary carrier strip and a secondary carrier strip and stamping a selected one of the upper contacts to have a front extension thereof leveled at a lowest position; insert-molding the upper row of contacts with an upper insulator to form an upper terminal module unit; forming a lower row of contacts each connected between another primary carrier strip and another secondary carrier strip and stamping a selected one of the lower contacts to have a front extension thereof leveled at a highest position; insert-molding the lower row of contacts with a lower insulator to form a lower terminal module unit; bringing the front extensions of the selected upper and lower contacts to be in touch with each other. The primary and secondary carrier strips are then severed and an over-mold applied.

### BACKGROUND OF THE INVENTION

### 1. Field of the Invention

The present invention relates to a method of making an electrical connector that includes two rows of contacts connected between a respective primary carrier strip and a respective secondary carrier strip during insert-molding contact module units thereof, wherein selected upper and lower contacts are processed to be in contact with each other reliably.

### 2. Description of Related Arts

U.S. Pat. No. 9,484,679 discloses an electrical connector, including: an insulative housing having a base and a tongue; and an upper and a lower rows of contacts secured to the insulative housing and exposed respectively to an upper and a lower faces of the tongue, each row of contacts including a ground contact and a power contact, each of the ground contacts and the power contacts having an extension at a front end thereof, wherein the extension of the upper ground contact and/or power contact directly abuts the extension of the lower ground contact and/or power contact in a vertical direction.

U.S. Patent Application Publication No. 2016/0099526 discloses a method of manufacturing an electrical connector, including a step of fixedly connecting an upper power terminal and a lower power terminal by riveting.

### SUMMARY OF THE INVENTION

A method of making an electrical connector, comprises the steps of: forming an upper row of contacts each connected between a primary carrier strip and a secondary carrier strip and stamping a selected one of the upper contacts to have a front extension thereof leveled at a lowest position; insert-molding the upper row of contacts with an upper insulator to form an upper terminal module unit; forming a lower row of contacts each connected between another primary carrier strip and another secondary carrier strip and stamping a selected one of the lower contacts to have a front extension thereof leveled at a highest position; insert-molding the lower row of contacts with a lower insulator to form a lower terminal module unit; bringing the front extensions of the selected upper and lower contacts to be in touch with each other; severing the primary and secondary carrier strips connected with the upper row of contacts and the primary and secondary carrier strips connected with the lower row of contacts; and over-molding the upper terminal module unit and the lower terminal module unit with an over-mold.

### BRIEF DESCRIPTION OF THE DRAWING

FIG. 1 is a perspective view of two contact rows for making an electrical connector in accordance with the present invention, each row of contacts being shown connected between a respective primary carrier strip and a respective secondary carrier strip;

FIG. 2 is a view similar to FIG. 1 but from another perspective;

FIG. 3 is a view similar to FIG. 1 further showing corresponding insulators;

FIG. 4 is a view similar to FIG. 3 but from another perspective;

FIG. 5 is a view similar to FIG. 3 further showing respective contact rows insert molded with respective insulators and a middle shielding plate;

FIG. 6 is a view similar to FIG. 5 but from another perspective;

FIG. 7 is a view showing two contact module units are brought together and further showing an over-mold;

FIG. 8 is a view similar to FIG. 7 but from another perspective;

FIG. 9 shows the over-mold is over-molded to the two contact module units;

FIG. 10 is a view similar to FIG. 9 but from another perspective;

FIG. 11 is a cross-sectional view showing an upper power contact and a lower power contact are in touch with each other; and

FIG. 12 is a perspective view and a partially enlarged view of the contacts with the primary carrier and the secondary carrier to show the offset of the power contact.

### DETAILED DESCRIPTION OF THE PREFERRED EMBODIMENT

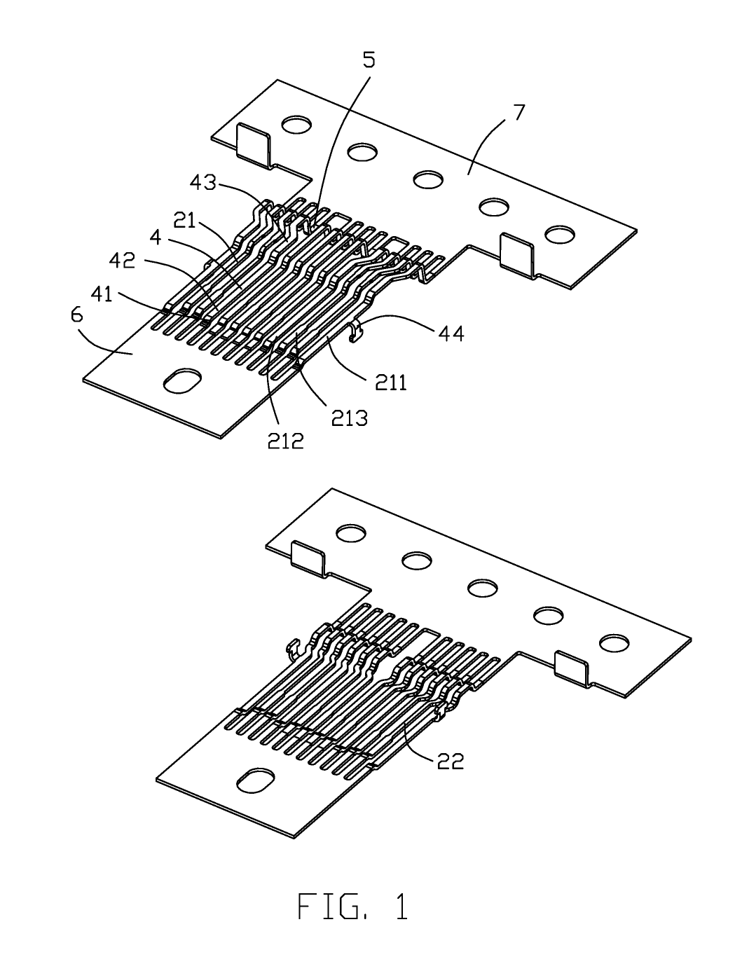

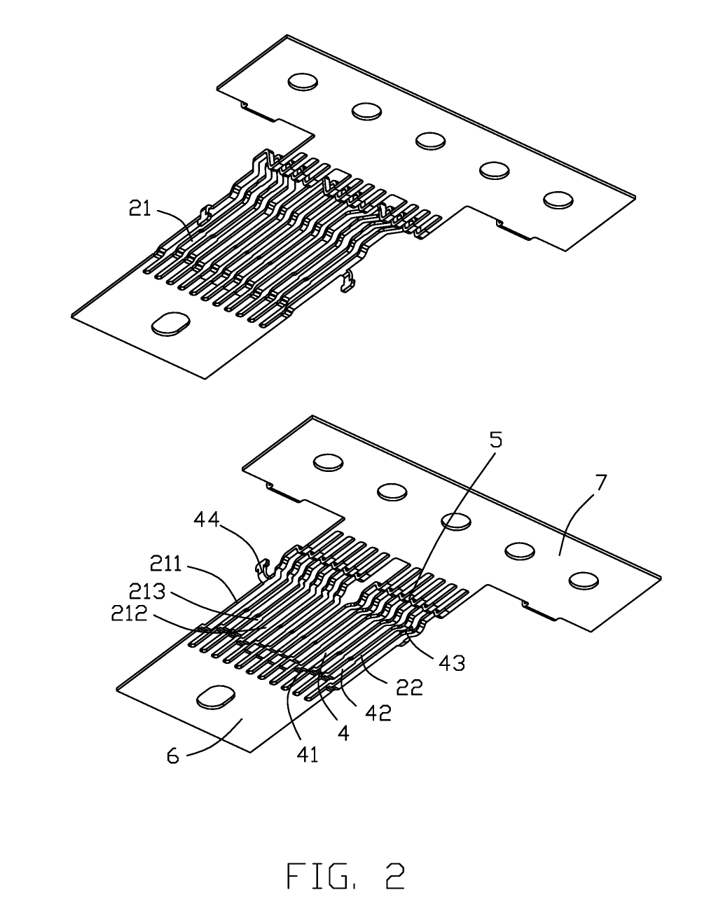

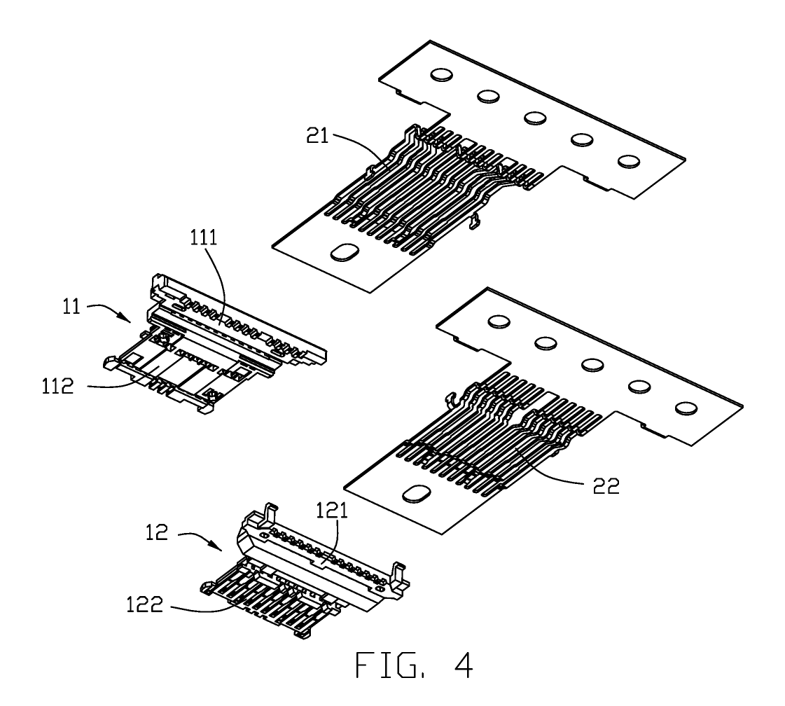

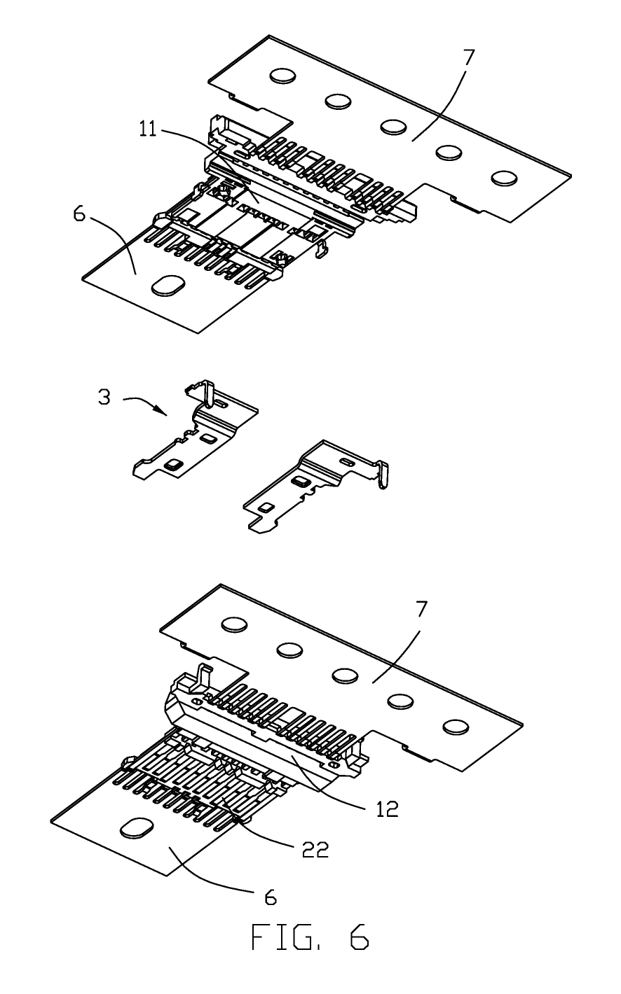

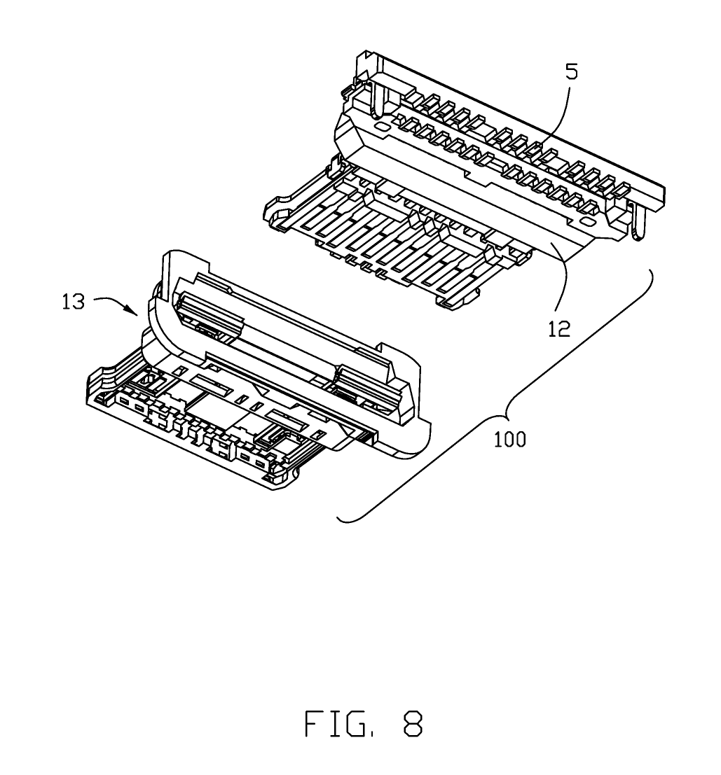

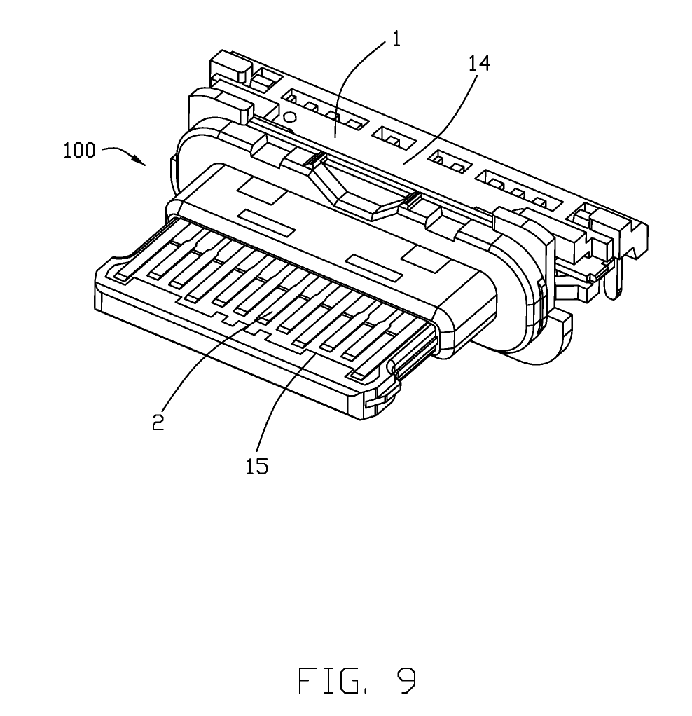

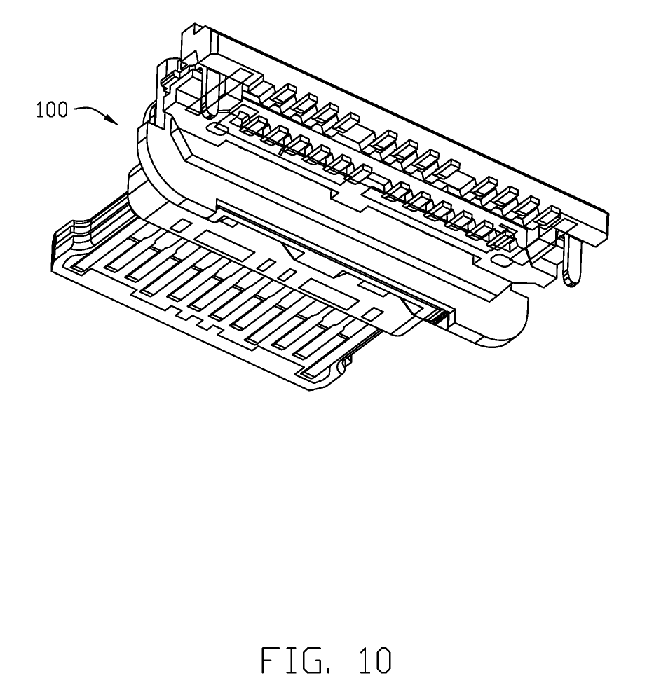

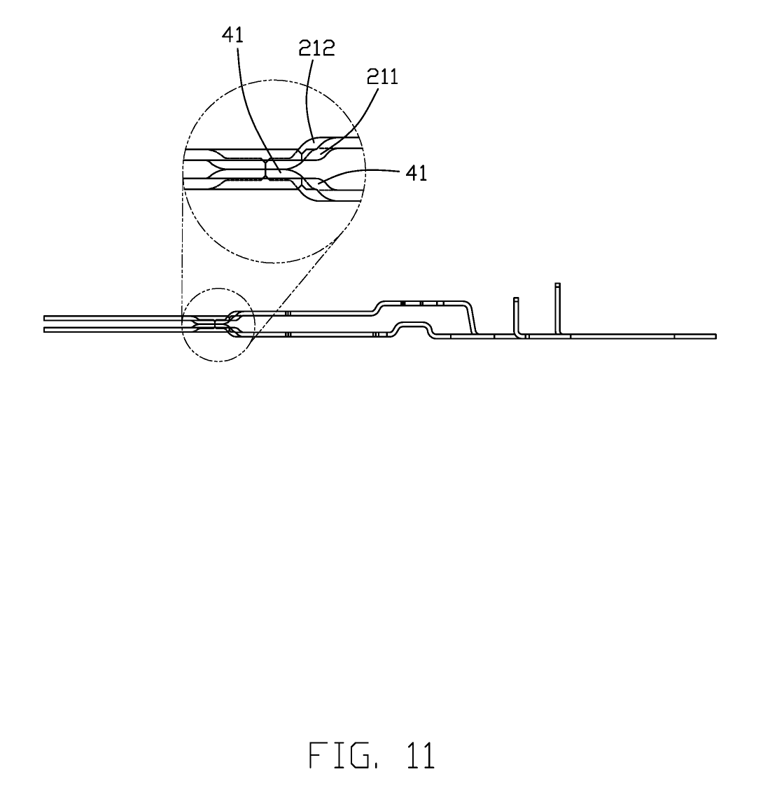

Referring to FIGS. 1-12, an electrical connector 100 made in accordance with the present invention comprises an insulative housing 1 and an upper row of contacts 21 and a lower row of contacts 22. The electrical connector 100 may further comprise a middle shielding plate 3 between the upper row of contacts 21 and the lower row of contacts 22.

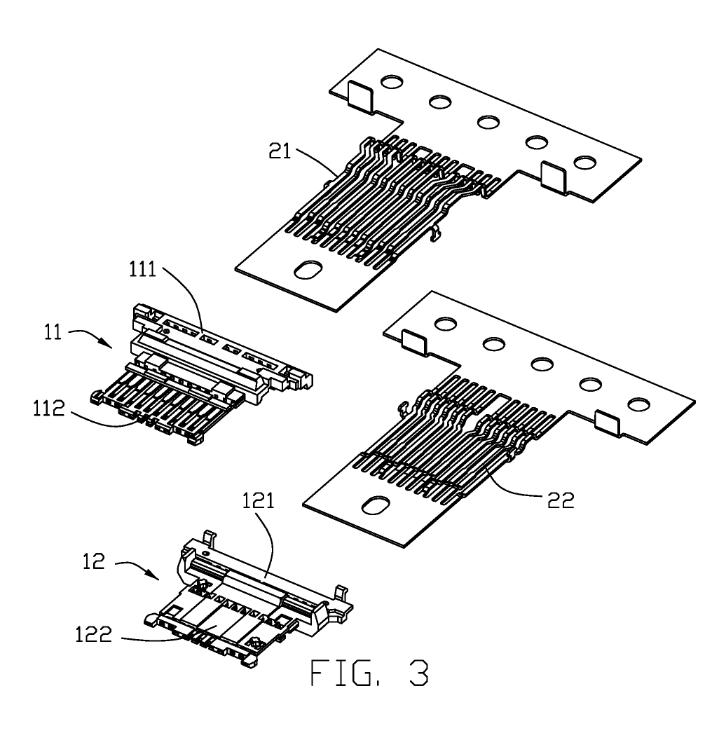

Referring to FIGS. 3-10, the insulative housing 1 is constructed of an upper insulator 11 insert-molded with the upper contacts 21, a lower insulator 12 insert-molded with the lower contacts 22, and an over-mold 13. The insulative housing 1 has a base 14 and a tongue 15 for exposing contacting portions of the contacts 2 in a well-known manner. The upper insulator 11 includes a base 111 and a tongue 112. The lower insulator 12 includes a base 121 and a tongue 122. The over-mold 13 includes a base 131 and a tongue 132. The bases 111/121/131 constitute an overall base 14 of the insulative housing 2; the tongues 112/122/132 constitute an overall tongue 15 of the insulative housing 2.

Contacts 2 in the upper and lower rows are generally arranged in a way to allow dual-orientation mating, as is well known in this art.

Referring to FIGS. 1-4, each row of contacts include two outermost ground contacts 211, a respective pair of high-speed signal contacts 213 next to each of the two ground contacts, a respective power contact 212 inwardly of and next to each pair of high-speed signal contacts, and other contacts. During manufacturing, each contact includes a main portion 4 having a front extension 41 and a rear soldering portion 5, and a primary carrier strip 7 is connected to the soldering portion 5 and a secondary carrier strip 6 is connected to the extension 41. It is noted that between adjacent contacts there is no bridging portions (to be cut off eventually) The main portion 4 includes a contacting portion 42 and a securing portion 43. The ground contact 211 has a side latch 44.

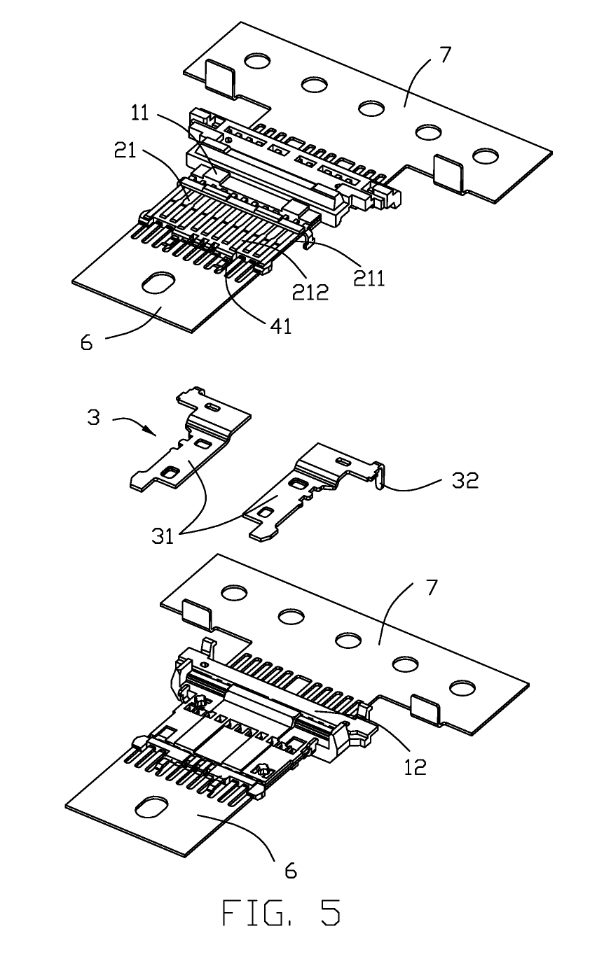

Referring to FIG. 5, the shielding plate 3 includes a pair of separate pieces and each piece has a main portion 31 and a grounding leg 32.

Referring to FIGS. 1-11, the electrical connector 100 is made by the following steps:

forming an upper row of contacts 21 each connected between a primary carrier strip 7 and a secondary carrier strip 6 and stamping a selected one (the upper power contact 212 in this embodiment) of the upper contacts to have a front extension 41 thereof leveled at a lowest position;
insert-molding the upper row of contacts 21 with an upper insulator 11 to form an upper terminal module unit;
forming a lower row of contacts 22 each connected between another primary carrier strip 7 and another secondary carrier strip 6 and stamping a selected one (the lower power contact 212 in this embodiment) of the lower contacts to have a front extension 41 thereof leveled at a highest position;
insert-molding the lower row of contacts with a lower insulator 12 to form a lower terminal module unit;
bringing the front extensions of the selected upper and lower contacts to be in touch with each other;
severing the primary and secondary carrier strips connected with the upper row of contacts and the primary and secondary carrier strips connected with the lower row of contacts; and
over-molding the upper terminal module unit and the lower terminal module unit with an over-mold 13.

In prior art designs involving two carrier strips connected at two ends of a row of contacts, in contrast to one carrier strip connected at one end and plural cut-off bridges between adjacent contacts, it is difficult to bring one contact (e.g., power contact) in the upper row to be in touch with another aligned contact (e.g., power contact) in the lower row. With a step of stamping the front extensions of these two selected contacts (e.g., power contacts) in a unique way, it is assured that the front extensions contact each other when brought together.

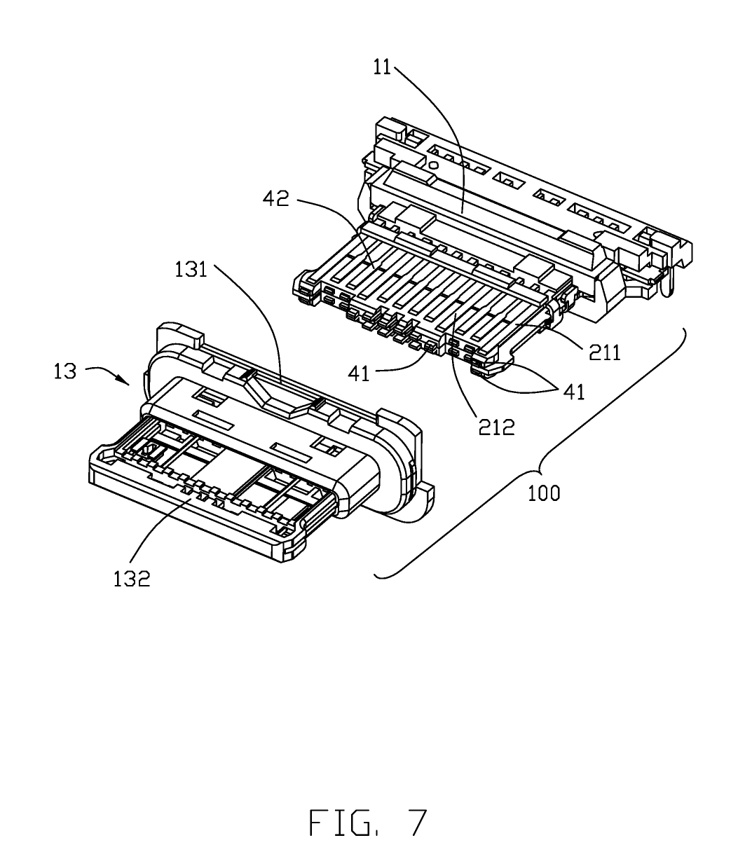

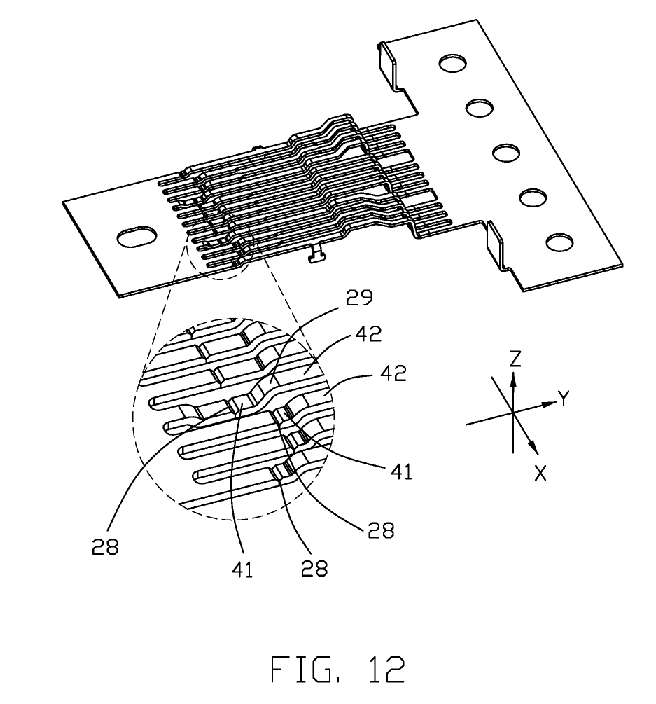

In brief, in the invention there are two rows of contacts spaced from each other in the vertical direction Z, and the contacts in each row are spaced from one another along the transverse direction X perpendicular to the vertical direction, and each contact extends in the front-to-back direction Y perpendicular to both the vertical direction Z and the transverse direction X. As shown in FIG. 7 in this embodiment there are twelve pairs of contacts spaced from each other in the transverse direction, and the contacts in each pair are opposite to each other in the vertical direction wherein each pair of the first pair and the twelfth pair belonging to the signal contacts 211 with farther front ends are spaced from each other in the vertical direction while adapted to be seated upon the shielding plate 3; each pair of second pair, the third pair, the eleventh pair and the tenth pair belonging to the signal contacts 213 with nearer front ends are spaced from each other; each pair of the fourth pair and the ninth pair belonging to the power contacts 212 with the farther front ends with opposite front extensions contacting each other in the vertical direction; each pair of the fifth pair, the sixth pair, the seventh pair and the eighth pair with the farther front ends are space from each other. As shown in FIG. 12, each contact 2 has a V-cut 28 for use with severing the contact 2 from the secondary carrier 6, and an offset section 29 between the contacting portion 42 and the front extension 41. Notably, in each row of the contact 2, the offset 29 of the power contact 212 is essentially aligned with the V-cut 28 of the neighboring signal contact 213 having the nearer front ends. On the other hand, in one row of contacts, the front extension 41 of the power contact 212 is located at a different lever with regard to those of the remaining contacts 2 and closer to the shielding plate in the vertical direction so as to contact that of another power contact 212 of the other row. In addition, in each row, the horizontal front extension 41 of the power contact 212 are offset from the plane of the secondary carrier 6 while those of other contacts 2 are coplanar with the plane of the secondary carrier 6.

What is claimed is:

1. A method of making an electrical connector, comprising the steps of:
forming an upper row of contacts each connected between a primary carrier strip and a secondary carrier strip and stamping a selected one of the upper contacts to have a front extension thereof leveled at a lowest position;
insert-molding the upper row of contacts with an upper insulator to form an upper terminal module unit;
forming a lower row of contacts each connected between another primary carrier strip and another secondary carrier strip and stamping a selected one of the lower contacts to have a front extension thereof leveled at a highest position;
insert-molding the lower row of contacts with a lower insulator to form a lower terminal module unit;
bringing the front extensions of the selected upper and lower contacts to be in touch with each other;
severing the primary and secondary carrier strips connected with the upper row of contacts and the primary and secondary carrier strips connected with the lower row of contacts; and
over-molding the upper terminal module unit and the lower terminal module unit with an over-mold.

2. The method as claimed in claim 1, wherein the step of bringing comprises sandwiching a middle shielding plate between the upper terminal module unit and the lower terminal module unit.

3. An electrical connector assembly comprising:
an insulative housing providing a mating tongue;
a first row and a second row of contacts retained in the housing and spaced from each other in a vertical direction, each row of contacts spanning in a transverse direction perpendicular to the vertical direction, each contact extending along a front-to-back direction perpendicular to both the vertical direction and the transverse direction, each of said contacts having a contacting portion exposed upon a mating surface of the mating tongue, and a horizontal front extension in front of said contacting portion with an offset section therebetween in the front-to-back direction;
a metallic shielding plate located between the first row of contacts and the second row of contacts in the vertical direction, wherein
in each row of contacts, a power contact having farther front ends has the corresponding offset section aligned with the horizontal front extension of a neighboring signal contact having a near front end, and the horizontal front extension of the power contact is closer to the shielding plate than the horizontal front extension of the signal contact in the vertical direction.

4. The electrical connector assembly as claimed in claim 3, wherein each row of contacts are originally connected to a carrier strip in front of the horizontal front extension, and the horizontal front extensions of all contacts are coplanar with the carrier except that of the power contact.

5. The electrical connector assembly as claimed in 3, wherein the housing includes an insulator having a zigzag front edge and each row of contacts are integrally formed within said insulator so as to have the signal contact having the near front end and the power contact having the farther front end have a similar exposed length of the corresponding horizontal front extensions thereof.

6. The electrical connector assembly as claimed in claim 5, wherein the exposed portions of the horizontal front extensions of all contacts are covered by an over-mold which is applied upon the insulator.

7. The electrical connector assembly as claimed in claim 6, wherein the offset sections of all contacts are embedded within the insulator while the horizontal front extension are embedded within the over-mold.

8. A contact carrier assembly for use with an insulator having a staggered front edge, comprising:
a contact strip extend along a transverse direction;
one row of contacts unitarily extending rearwardly from a same side of the contact strip in a front-to-back direction perpendicular to the transverse direction and spaced from one another in said transverse direction, each contact including a contacting portion adapted to be exposed upon a mating surface of a mating tongue partially constructed by the insulator, a horizontal front extension in front of said contacting portion with an offset section therebetween in the front-to-back direction;
the contacts including power contacts and signal contacts neighboring the power contacts in the transverse direction, wherein
in a side view taken along the transverse direction, the horizontal front extension of the power contacts are located in front of that of the signal contact, and the offset section of the power contact is dimensioned larger than that of the signal contact in a vertical direction perpendicular to both the transverse direction and the front-to-back direction so as to have the horizontal front extension of the power contact spaced from the corresponding mating surface of the mating tongue with a longer distance than that of the signal contact.

9. The contact carrier assembly as claimed in claim 8, wherein in said side view, the offset section of the signal contact is aligned with the horizontal front extension of the power contact in the transverse direction.
